(19) United States
(12) Patent Application Publication
(10) Pub. No.: US 2006/0232692 A1
(43) Pub. Date: Oct. 19, 2006

(54) Image pickup apparatus

(75) Inventor: Yasuo Takane, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/402,816

(22) Filed: Apr. 13, 2006

(30) Foreign Application Priority Data
Apr. 14, 2005 (JP) 2005-116642

(51) Int. Cl. H04N 9/64

(52) U.S. Cl. 348/248

(57) ABSTRACT

According to the present invention, when determining a smear signal from a digital signal having a predetermined bit width derived from an optical black area of a solid-state image sensor, a digital signal having a bit width smaller than the bit width of the digital signal is used. Therefore, the size of the circuit for generating a smear correction signal or the like can be reduced, and thus, the power consumption and the cost can be reduced.

### BACKGROUND OF THE INVENTION

1. Field of the Invention

The present invention relates to an image pickup apparatus. In particular, it relates to a smear correction technique for an image pickup apparatus, such as a digital camera and a video camera, that has a function of preventing degradation of the image quality due to a smear phenomenon.

2. Description of the Related Art

When an image of a high-luminance object, such as the sun or a light, is shot using an image pickup apparatus having a charged coupled device (CCD) image sensor, a bright line in the form of a stripe extending vertically appears in the image. Such a phenomenon is called smear phenomenon, which is caused by leakage of an excessive charge on a photodiode having received an excessive amount of incident light to a vertical transfer channel thereof during transfer of charges on the photodiodes (photoelectric conversion elements) of the CCD to the respective vertical transfer channels, or caused by leakage of the incident light itself to the vertical transfer channel, which makes a charge occur in the vertical transfer channel.

To eliminate such a smear phenomenon, in conventional image pickup apparatus, output signals derived from an optical black area (OB area) composed of a plurality of lines of pixels of the CCD image sensor are added and averaged to form one line of signals, the one line of signals is stored in a line memory, and the stored signal is subtracted from a signal derived from an effective pixel area of the CCD image sensor (Japanese Patent Application Laid-Open No. 7-67038).

### SUMMARY OF THE INVENTION

In the Japanese Patent Application Laid-Open No. 7-67038, however, there is not described any technique for reducing the size of the circuit for smear correction. In addition, if an extremely significant smear occurs, there arises a problem that the subtrahend for the signal at the horizontal pixel position where the smear occurs becomes too large, causing a stripe-shaped noise.

The present invention has been devised in view of such circumstances, and an object of the present invention is to provide an image pickup apparatus in which a circuit for smear correction has a reduced size, and the quality of the smear correction is improved.

In order to attain the object described above, according to a first aspect of the present invention, there is provided an image pickup apparatus, comprising: a solid-state image sensor having an effective pixel area and an optical black area composed of a plurality of lines of pixels; an A/D converter which converts analog signals output from the solid-state image sensor into digital signals having a predetermined bit width; an average value calculation device which receives digital signals having a bit width smaller than the bit width of the digital signals derived from the optical black area and calculates one line of digital signals by averaging digital signals derived from the plurality of lines of pixels based on the received digital signals; a line memory which stores the one line of digital signals having the smaller bit width calculated by the average value calculation device; a smear detection device which detects the horizontal position of a pixel in the effective pixel area at which a smear occurs, based on the one line of digital signals stored in the line memory; and a smear correction device which corrects, based on the digital signals stored in the line memory, a digital signal derived from the pixel position detected by the smear detection device of the digital signals having the predetermined bit width derived from the effective pixel area.

That is, when determining a smear signal from a digital signal having a predetermined bit width derived from the optical black area of the solid-state image sensor, a digital signal having a bit width smaller than the bit width of the digital signal can be used to reduce the size of the circuit including the average value calculation device and the line memory. Owing to the characteristic of the smear signal, there is an area that does not require a high signal precision, so that low-order bits can be reduced when determining the smaller bit width.

According to a second aspect of the present invention, in the image pickup apparatus according to the first aspect of the present invention, the smear detection device comprises: a calculation device which calculates the difference between an average value of the digital signals derived from the optical black area of the solid-state image sensor and each of the digital signals stored in the line memory; and a comparison device which detects the horizontal position of a pixel at which a smear occurs based on comparison between the calculated difference and a preset threshold.

According to a third aspect of the present invention, in the image pickup apparatus according to the first or second aspect of the present invention, the smear correction device determines a difference between the digital signal derived from the pixel position detected by the smear detection device and the average value of the digital signals derived from the optical black area of the solid-state image sensor and subtracts the determined difference from the digital signals having the predetermined bit width derived from the effective pixel area.

According to a fourth aspect of the present invention, the image pickup apparatus according to the third aspect of the present invention further comprises a correction assessment device which cancels the smear correction based on the difference in the case where the determined difference is greater than a predetermined value. As a result, excessive smear correction is avoided. If smear correction is excessive, a black stripe appears as in the conventional technique. However, according to the fourth aspect of the present invention, occurrence of such a black stripe is prevented to improve the performance of the smear correction.

According to a fifth aspect of the present invention, the image pickup apparatus according to any of the first to fourth aspects of the present invention further comprises a bit selector which is provided at a stage preceding the average value calculation device, receives the digital signals having the predetermined bit width, derives a digital signal composed of a width of bits at any bit positions from each of the digital signals having the predetermine bit width, and outputs the digital signal to the average value calculation device. In this case, depending on the characteristics of the image pickup device or the shooting conditions, such as for shooting an object whose image tends to be noisy, the bit width and the bit positions can be appropriately selected.

According to a sixth aspect of the present invention, the image pickup apparatus according to any of the first to fourth aspects of the present invention further comprises a limiter which is provided at a stage preceding the average value calculation device and limits the digital signal input to the average value calculation device to a preset numerical value.

According to a seventh aspect of the present invention, the image pickup apparatus according to any of the first to fourth aspects of the present invention further comprises a knee circuit which is provided at a stage preceding the average value calculation device and performs a knee correction of the digital signal input to the average value calculation device.

According to an eighth aspect of the present invention, the image pickup apparatus according to the seventh aspect of the present invention further comprises a correction value modification device which imparts an input/output characteristic inverse to a knee characteristic of the knee circuit to the digital signal derived from the pixel position detected by the smear detection device and stored in the line memory, which is subtracted from the digital signal derived from the pixel position. Thus, the signal compressed by the knee circuit can be expanded again.

According to a ninth aspect of the present invention, the image pickup apparatus according to any of the first to fourth aspects of the present invention further comprises a coring circuit which is provided at a stage preceding the average value calculation device and performs a coring correction of the digital signal input to the average value calculation device. Since the noise component in the input digital signal is suppressed, an appropriate signal for smear correction can be obtained.

According to a tenth aspect of the present invention, the image pickup apparatus according to any of the first to fourth aspects of the present invention further comprises a digital filter which is provided at a stage preceding the average value calculation device and performs filtering of the digital signal input to the average value calculation device, the digital filter reducing the value of a attention point in the case where the value of the attention point is greater than the value of a point in the vicinity of the attention point. As a result, even if there is a pixel defect in the optical black area of the solid-state image sensor, the effect of the pixel defect can be removed.

According to an eleventh aspect of the present invention, in the image pickup apparatus according to the tenth aspect of the present invention, the digital filter is a median filter, a low-pass filter or an isolated point removing filter.

According to the present invention, when determining a smear signal from a digital signal having a predetermined bit width derived from an optical black area of a solid-state image sensor, a digital signal having a bit width smaller than the bit width of the digital signal is used. Therefore, the size of the circuit for generating a smear correction signal or the like can be reduced, and thus, the power consumption and the cost can be reduced.

### BRIEF DESCRIPTION OF THE DRAWINGS

FIG. 1 is a schematic plan view of an exemplary CCD;

FIG. 2 is a block diagram showing an image pickup apparatus according to an embodiment of the present invention;

FIG. 3 is a block diagram showing an exemplary internal structure of an image signal processing circuit;

FIG. 4 is a block diagram showing a smear correction circuit according to a first embodiment of the present invention;

FIG. 5 is a graph showing an example of an average data sequence (OB values) for one line of an OB area;

FIG. 6 is a flowchart for illustrating a procedure of a smear correction method;

FIG. 7 is a block diagram showing a smear correction circuit according to a second embodiment of the present invention;

FIG. 8 is a block diagram showing a smear correction circuit according to a third embodiment of the present invention;

FIG. 9 is a graph for illustrating a limiter;

FIG. 10 is a block diagram showing a smear correction circuit according to a fourth embodiment of the present invention;

FIG. 11 is a flowchart for illustrating an operation of a correction assessment circuit;

FIG. 12 is a block diagram showing a smear correction circuit according to a fifth embodiment of the present invention;

FIGS. 13A and 13B are graphs for illustrating a knee circuit and a correction value modification circuit;

FIG. 14 is a block diagram showing a smear correction circuit according to a sixth embodiment of the present invention;

FIG. 15 is a flowchart for illustrating an operation of the correction value modification circuit;

FIG. 16 is a block diagram showing a smear correction circuit according to a seventh embodiment of the present invention;

FIG. 17 is a graph for illustrating a coring circuit;

FIG. 18 is a block diagram showing a smear correction circuit according to an eighth embodiment of the present invention; and

FIG. 19 is a block diagram showing a smear correction circuit according to a ninth embodiment of the present invention.

### DETAILED DESCRIPTION OF THE PREFERRED EMBODIMENTS

Now, an image pickup apparatus according to a preferred embodiment of the present invention will be described in detail with reference to the accompanying drawings.

[Structure of Solid-State Image Sensor]

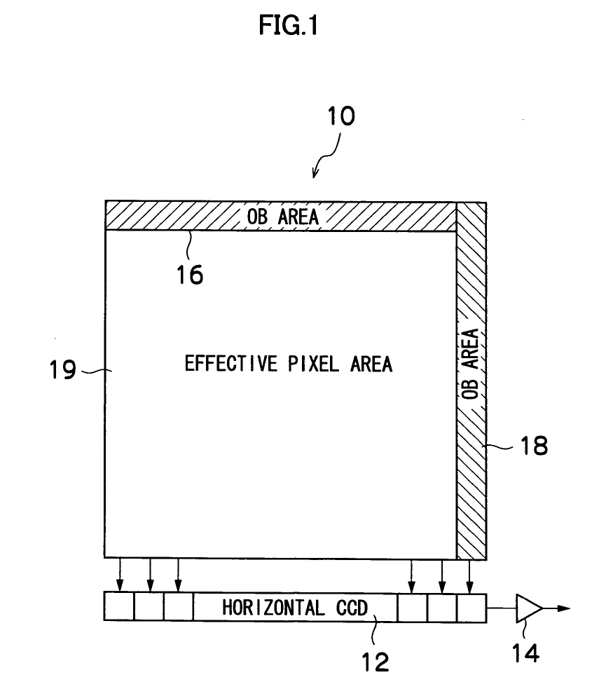

First, a structure of a CCD image sensor used in an image pickup apparatus according to the present invention will be described. FIG. 1 is a schematic plan view of an exemplary CCD solid-state image sensor (referred to as CCD, hereinafter).

A CCD 10 is a two-dimensional image pickup device (image sensor) that comprises an array of multiple light-receiving cells arranged in a horizontal direction (a row direction) and in a vertical direction (a column direction) at a certain period.

A vertical transfer channel (a vertical CCD) is formed at the side of each light-receiving cell. Charges accumulated in the light-receiving cells are passed to the respective vertical CCDs when the CCD is driven, and the charges on the vertical CCDs are sequentially transferred in a downward direction in FIG. 1.

A horizontal transfer channel (a horizontal CCD) 12 is disposed at a lower part of the CCD 10 (disposed adjacent to the bottom of each line of vertical CCDs) and receives the signal charges sequentially transferred from the line of vertical CCDs. The horizontal CCDs 12 are two-phase driven and sequentially transfer the charges thereon in the horizontal direction. The horizontal CCD at the last stage (the rightmost stage in FIG. 1) is connected to an output section 14. The output section 14 comprises an output amplifier, detects the signal charges input thereto and outputs the signal charges in the form of signal voltages. In this way, the signals produced by photoelectric conversion by the light-receiving cells are output in the form of dot-sequential signal sequence.

In addition, the CCD 10 has optical black areas (OB areas) 16 and 18, which are light-shielded, along the upper and right edges thereof and an effective pixel area 19, which is not light-shielded. According to this embodiment, the OB area 16 is composed of the uppermost two lines of pixels of the CCD 10.

[Example of Structure of Image Pickup Apparatus]

Now, an image pickup apparatus according to an embodiment of the present invention will be described.

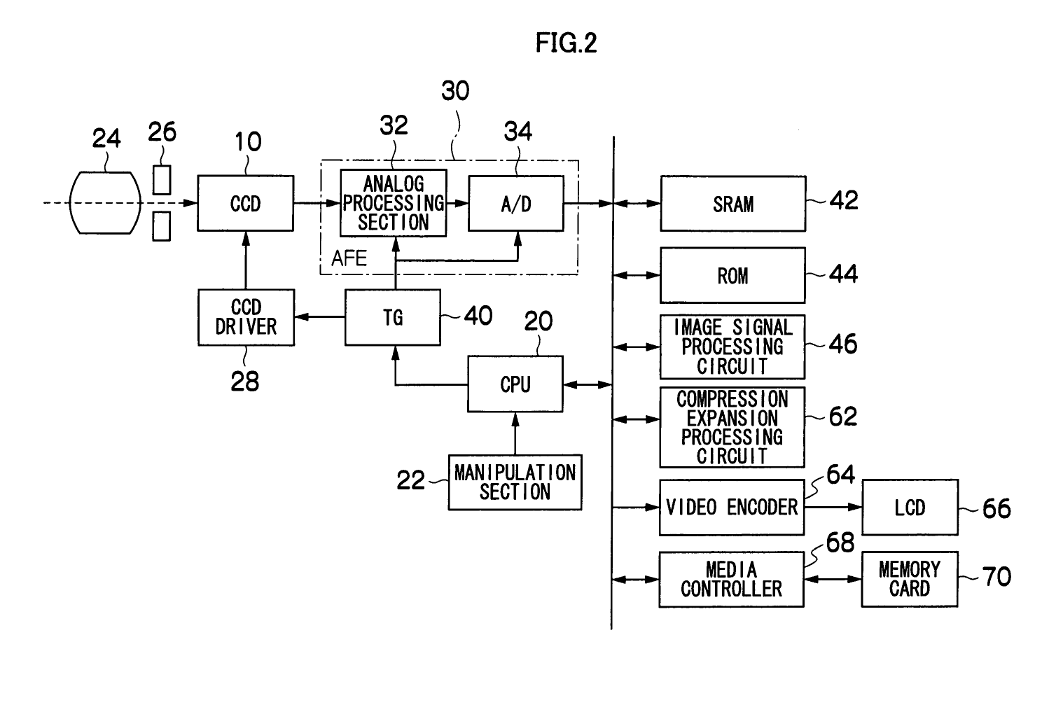

FIG. 2 is a block diagram showing an image pickup apparatus according to an embodiment of the present invention. The image pickup apparatus has the CCD 10 mounted thereon.

The operation of the whole image pickup apparatus is generally controlled by a central processing unit (CPU) 20. A manipulation section 22 comprises a power supply switch, a shutter button, a mode switching key for switching between a shooting mode and a reproduction mode, and a crosshair multifunction key for entering various commands, such as zooming and frame-by-frame advance, and the like. Various manipulation signals from the manipulation section 22 are supplied to the CPU 20. The image pickup apparatus has not only a static-image shooting mode (static image mode) in which the apparatus shoots a static image each time the shutter button is turned on but also a moving-image shooting mode (moving image mode) in which the apparatus shoots a sequence of images at a predetermined frame rate while the shutter button is turned on. An appropriate mode can be selected from among these modes by a manipulation on the manipulation section 22.

In either case of shooting a static image or moving image, image light representing an object is focused on a light-receiving surface of the CCD 10 through a taking lens 24 and a diaphragm 26. A charge accumulated on the CCD 10 is read out as a voltage signal by a CCD driver 28, and the voltage signal is output to an analog front end (AFE) 30.

The AFE 30 comprises an analog processing section 32 including a correlated double sampling (CDS) circuit, a color separation circuit, a gain control circuit or the like and an A/D converter 34. The AFE 30 performs correlated double sampling of input signals, performs color separation to separate the input signals into color signals of colors R, G and B, and adjusts the signal level of each color signal. The analog signal output from the analog processing section 32 is converted into a 12-bit digital signal by the A/D converter 34 and then supplied to an image signal processing circuit 46 as CCD-RAW data of R, G or B.

A timing generator (TG) 40 applies a timing signal to the CCD driver 28 and the AFE 30 in accordance with an instruction from the CPU 20, and the timing signal allows the circuits to be synchronized.

A memory (static RAM (SRAM)) 42 serves as a work memory that temporarily stores image data or is used in an image processing described later. A ROM 44 previously stores a program, an adjusted value and the like, which are appropriately read out.

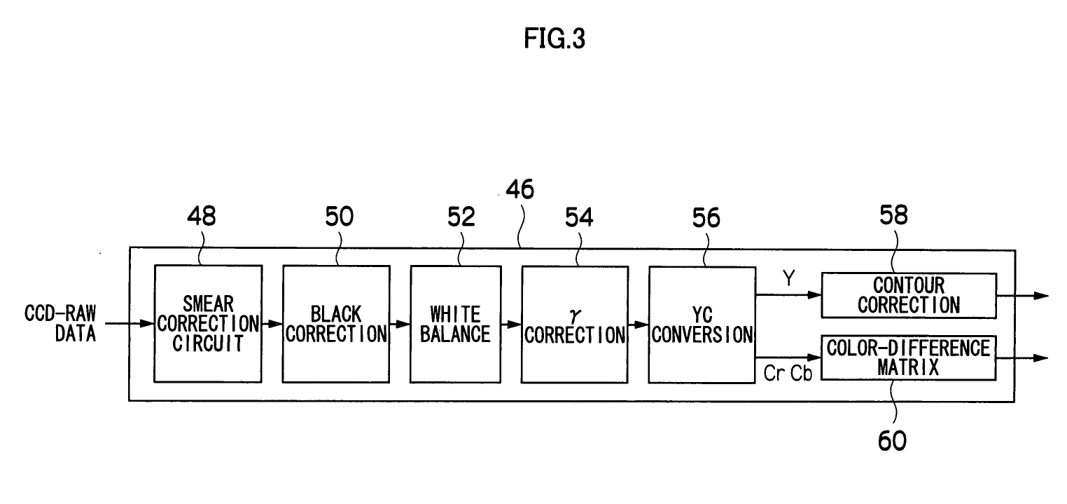

As shown in FIG. 3, an image signal processing section 46 comprises a smear correction circuit 48, a black correction circuit 50, a white balance adjustment circuit 52, a gamma correction circuit 54, a YC conversion circuit 56, a contour correction circuit 58, a color-difference matrix circuit 60 and the like and performs various signal processings on the CCD-RAW data input from the AFE 30.

The smear correction circuit 48 removes any smear component of the input CCD-RAW data. Details of the smear correction circuit 48 will be described later. The data having been subjected to smear correction is then subjected to black level correction by the black correction circuit 50. The black level correction is performed with reference to the cumulative average value of data derived from the OB areas 16 and 18 shown in FIG. 1.

Then, the white balance adjustment circuit 52 and the gamma correction circuit 54 perform white balance adjustment and gamma correction of the R, G and B data, respectively, and the YC conversion circuit 56 performs YC conversion to generate brightness data Y and color-difference data Cᵣ and C_{b} from the R, G and B data. The brightness data Y is subjected to a contour enhancement processing in the contour correction circuit 58, and the color-difference data Cᵣ and C_{b} are subjected to color correction in the color-difference matrix circuit 60 to enhance the color reproducibility.

The image data (YC data) produced by the processing by the image signal processing circuit 46 is encoded by a video encoder 64 and output to a liquid crystal display (LCD) monitor 66 provided on the back of the camera. Thus, the object image is displayed on a display screen of the LCD 66.

Besides, the YC data produced by the processing by the image signal processing circuit 46 is output also to a compression/expansion processing circuit 62, is subjected to a predetermined compression processing, such as of joint photographic experts group (JPEG), and then is recorded in a memory card 70 via a media controller 68.

Now, the smear correction circuit 48 will be described.

### First Embodiment

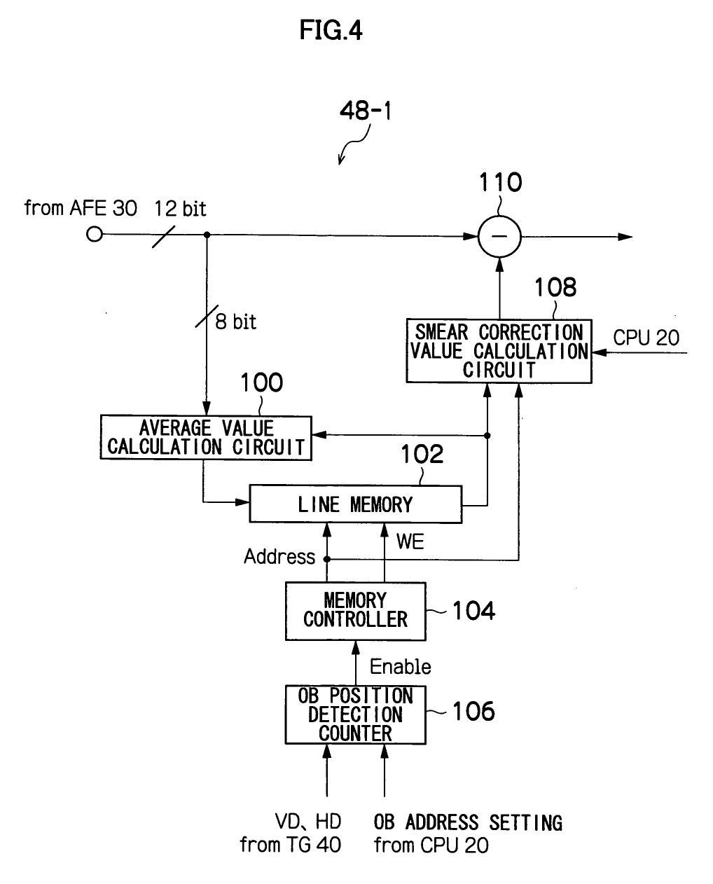

FIG. 4 is a block diagram showing a smear correction circuit according to a first embodiment of the present invention.

In FIG. 4, a smear correction circuit 48-1 primarily comprises an average value calculation circuit 100, a line memory 102, a memory controller 104, an OB position detection counter 106, a smear correction value calculation circuit 108 and a subtraction circuit 110.

To the average value calculation circuit 100, 8-bit data of the 12-bit CCD-RAW data from the AFE 30 is input. The 8 bits are, for example, low-order 8 bits of the 12 bits. However, in the present invention, the low-order 8 bits are not necessarily the first to eighth low-order bits but may be the third to tenth low-order bits, for example. This is because the area to be compressed does not require a high signal precision owing to the characteristics of the smear signal.

The average value calculation section 100 is composed of an adder circuit and a divider circuit and has another input to receive 8-bit data output from the line memory 102. The average value calculation section 100 sums the two pieces of input data, divides the sum by 2, thereby determining the average value of the two pieces of input data, and outputs the average value to the line memory 102.

The line memory 102 can store pieces of 8-bit data derived from one line of pixels of the CCD 10. Addressing in the line memory 102 on which data reading/writing is performed and data writing to the line memory 102 are performed in accordance with an address signal “Address” and a write enable signal WE from the memory controller 104, respectively.

The memory controller 104 outputs the address signal “Address” and the write enable signal WE in accordance with an enable signal “Enable” input from the OB position detection counter 106. That is, the OB position detection counter 106 is reset by a vertical synchronization signal VD input from the TG 40 and then counts horizontal synchronization signals HD input from the TG 40, thereby determining the line from which the data currently being output from the AFE 30 is derived. In addition, the OB position detection counter 106 has the address of the OB area 16 of the CCD 10 set by the CPU 20. Only during a period of time in which the data of the line of pixels of the OB area 16 (the uppermost two lines of pixels of the CCD 10, in this embodiment) is input, the OB position detection counter 106 outputs the enable signal “Enable” to the memory controller 104 to permit the memory controller 104 to operate.

Therefore, during the period in which the data of the OB area 16 is input, the average value calculation circuit 100 and the line memory 102 cooperate to calculate a data sequence for one line by vertically adding and averaging the data derived from the two lines of pixels of the OB area 16.

In this way, the line memory 102 stores and retains the data sequence for one line of pixels of the OB area 16, and the data sequence is output to the smear correction value calculation circuit 108 along with the address signal Address (a signal representing a horizontal pixel position in that one line).

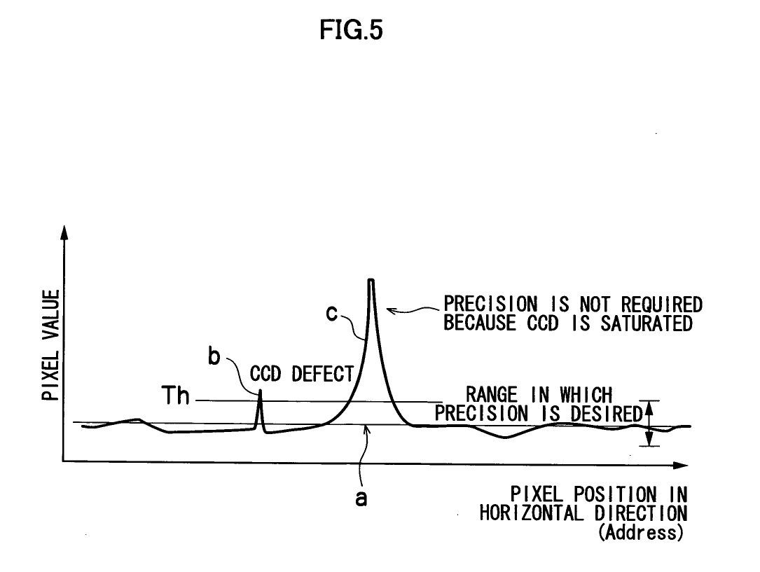

FIG. 5 shows an example of an averaged data sequence (OB values) for one line of the OB area 16. In FIG. 5, reference character a designates an average value of the data of the whole OB area of the CCD 10, and reference characters b and c designate values significantly greater than the average value a. Reference character b indicates a point where a pixel defect in the OB area results in a great value, and reference character c indicates a point where a smear component introduced into the OB area results in a great value.

The smear correction value calculation circuit 108 has another input to receive a predetermined threshold Th for smear detection from the CPU 20. As shown in FIG. 5, the smear correction value calculation circuit 108 detects a point where an OB value of the average OB values for one line of the OB area 16 exceeds the threshold Th as a point where a smear occurs, and calculates the smear correction value for the data of the same point transmitted on the main line. That is, the average value of the data of the OB area is subtracted from the OB value at the point where the threshold Th is exceeded, and the difference value is determined as the smear correction value. The smear correction value calculation circuit 108 outputs the smear correction value thus calculated to the subtraction circuit 110.

The subtraction circuit 110 has another input to receive the data transmitted on the main line, subtracts the smear correction value from the data transmitted on the main line, and outputs the difference as smear-corrected data. The smear correction value calculation circuit 108 outputs, to the subtraction circuit 110, the smear correction value for the same address as the horizontal address of the data transmitted on the main line to the subtraction circuit 110.

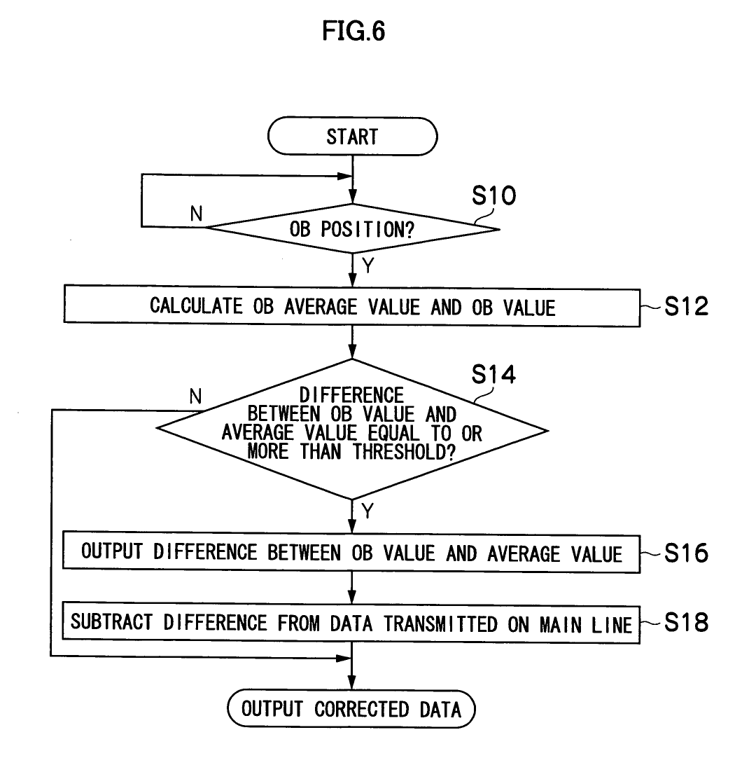

FIG. 6 is a flowchart for illustrating a procedure of the smear correction method described above.

Referring to FIG. 6, it is determined whether the data input from the AFE 30 (CCD-RAW data) is data of an OB area or not (step S10), and if the data is data of an OB area, an average value of all the data of the OB area (average OB value) is calculated, and the data of the two lines of pixels of the OB area 16 are vertically averaged to calculate a data sequence (OB values) for one line (step S12).

Then, for each horizontal pixel position, it is determined whether or not the difference between the OB value at the pixel position and the OB average value is equal to or more than a predetermined threshold (step S14). If the difference is equal to or more than the threshold, the difference is output to the subtraction circuit 110 as a smear correction value (step S16), and the subtraction circuit 110 subtracts the smear correction value from the data transmitted on the main line (step S18). If the difference is equal to or less than the threshold, the data transmitted on the main line is not subjected to smear correction.

### Second Embodiment

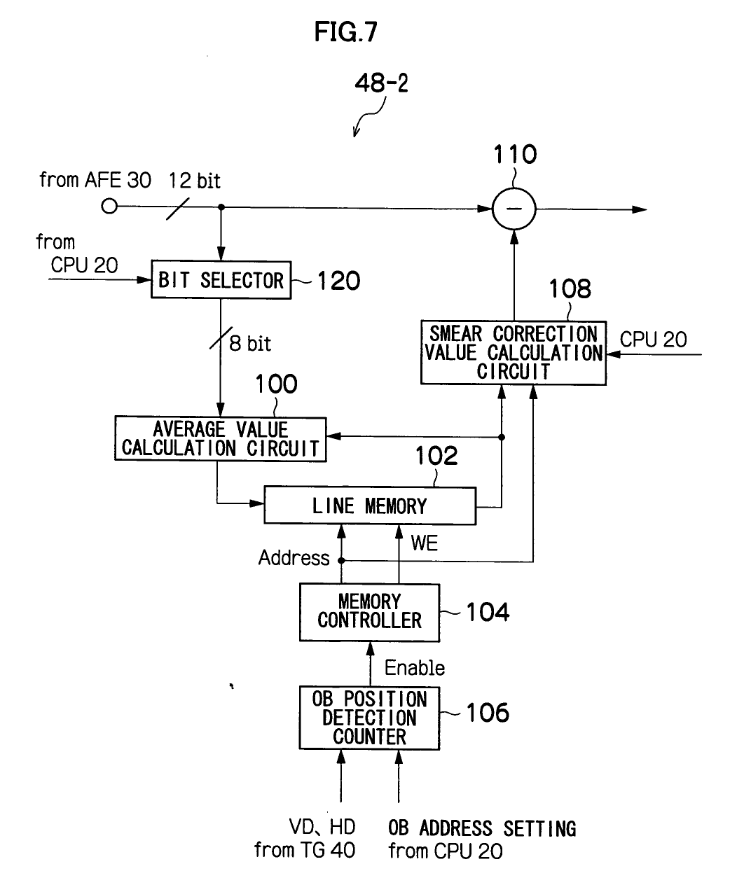

FIG. 7 is a block diagram showing a smear correction circuit according to a second embodiment of the present invention. The same components as in the first embodiment shown in FIG. 4 are designated by the same reference numerals, and detailed description thereof will be omitted.

A smear correction circuit 48-2 shown in FIG. 7 differs from the smear correction circuit 48-1 according to the first embodiment in that a bit selector 120 is additionally provided in front of the average value calculation circuit 100.

The bit selector 120 can select any 8 bits from the 12-bit CCD-RAW data and outputs the 8 bits to the average value calculation circuit 100. For example, the 8 bits selected from the 12 bits can be the third to tenth bits. In addition, depending on the characteristics of the CCD 10 or the shooting conditions, such as for shooting a noisy scene, the bit width and the bit positions can be appropriately selected in accordance with the instruction from the CPU 20. This is because the area to be compressed does not require a high signal precision owing to the characteristics of the smear signal.

Since the bit selector 120 reduces the number of bits, the size of the following stages of the circuit can be reduced.

In the case where the bit selector 120 selects the third to tenth bits from the 12 bits, the data input to the average value calculation circuit 100 has a size magnified by eight times. Thus, the smear correction value calculation circuit 108 has to reduce the input data by a factor of 8 (3-bit shift) to provide the OB value.

### Third Embodiment

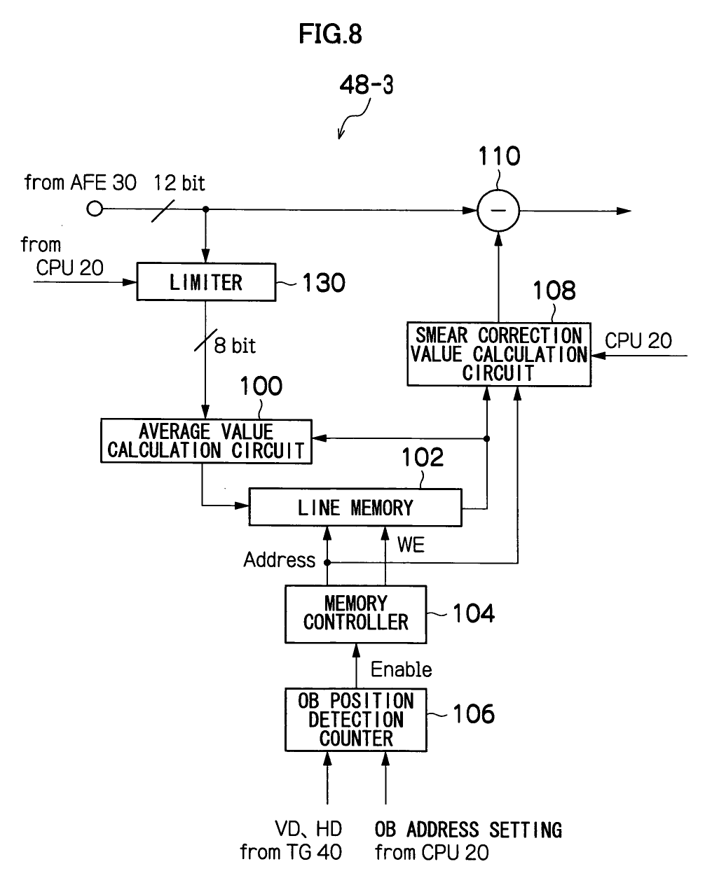

FIG. 8 is a block diagram showing a smear correction circuit according to a third embodiment of the present invention. The same components as in the first embodiment shown in FIG. 4 are designated by the same reference numerals, and detailed description thereof will be omitted.

A smear correction circuit 48-3 shown in FIG. 8 differs from the smear correction circuit 48-1 according to the first embodiment in that a limiter 130 is additionally provided in front of the average value calculation circuit 100.

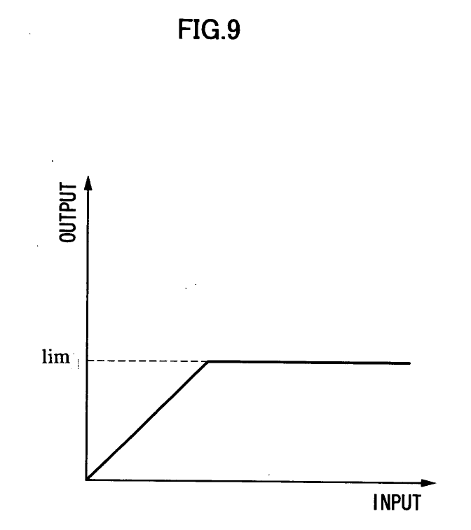

The limiter 130 has a predetermined limit value lim set by the CPU 20. As shown in FIG. 9, the limiter 130 is a circuit for limiting the 12-bit CCD-RAW data to the predetermined limit value lim. Low-order 8 bits of the CCD-RAW data limited by the limiter 130 are output to the average value calculation circuit 100. In this example, the limit value is preferably a maximum of values that are of less than 8 bits and do not exceed 8 bits (that is, do not overflow) in the following addition step.

Thus, occurrence of data overflow during the calculation of the OB value can be prevented.

### Fourth Embodiment

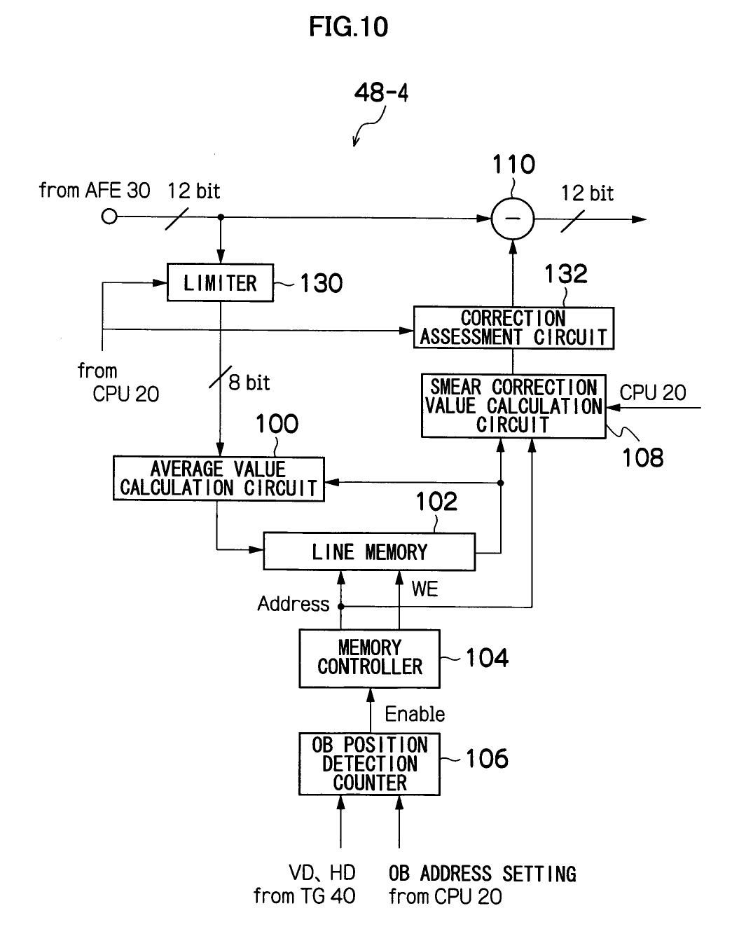

FIG. 10 is a block diagram showing a smear correction circuit according to a fourth embodiment of the present invention. The same components as in the third embodiment shown in FIG. 8 are designated by the same reference numerals, and detailed description thereof will be omitted.

A smear correction circuit 48-4 shown in FIG. 10 differs from the smear correction circuit 48-3 according to the third embodiment in that a correction assessment circuit 132 is additionally provided following the smear correction value calculation circuit 108.

As described above, the limit value lim of the limiter 130 is the maximum value that does not overflow during the following addition step. Therefore, as for the CCD-RAW data exceeding the limit value, the OB value cannot be calculated accurately. In addition, if the smear correction value calculated by the smear correction value calculation circuit 108 is too large, the subtraction circuit 110 subtracts the too large smear correction value from the data transmitted on the main line, and thus, there arises a problem that a stripe noise occurs due to the overcorrection.

The correction assessment circuit 132 according to the fourth embodiment determines whether the smear correction value is greater than a predetermined value or not. If the smear correction value is greater than the predetermined value, the correction assessment circuit 132 outputs any of zero, the average value or a default value (an appropriate value that avoids excessive smear correction) to the subtraction circuit 110 instead of the smear correction value.

Besides, the predetermined value used by the correction assessment circuit 132 as an assessment criterion is the same as the limit value lim of the limiter 130.

The correction assessment circuit 132 serves to prevent excessive smear correction. That is, the correction assessment circuit 132 prevents occurrence of a stripe noise that occurs when excessive smear correction is performed.

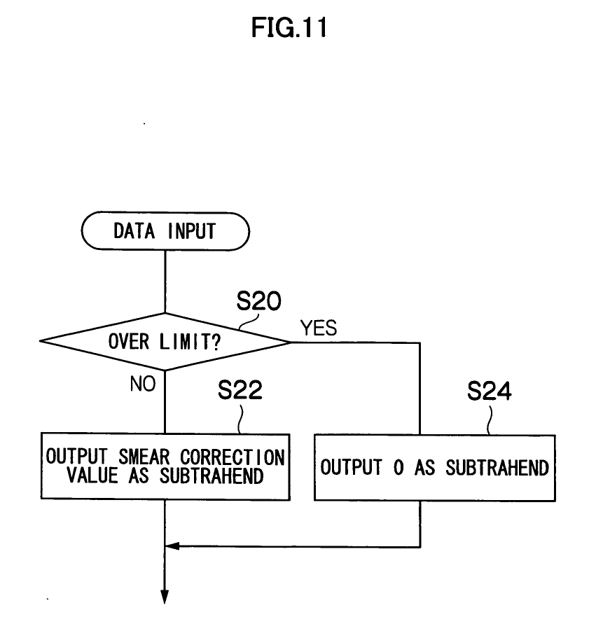

FIG. 11 is a flowchart for illustrating an operation of the correction assessment circuit 132.

Referring to FIG. 11, the correction assessment circuit 132 compares the smear correction value input from the smear correction value calculation circuit 108 with the limit value lim input from the CPU 20 to determine whether the smear correction value is greater than the limit value lim or not (step S20).

If the smear correction value is not greater than the limit value lim, the correction assessment circuit 132 outputs the smear correction value to the subtraction circuit 110 as a subtrahend (step S22). If the smear correction value is greater than the limit value lim, the correction assessment circuit 132 outputs zero (or a default value) to the subtraction circuit 110 as a subtrahend (step S24).

### Fifth Embodiment

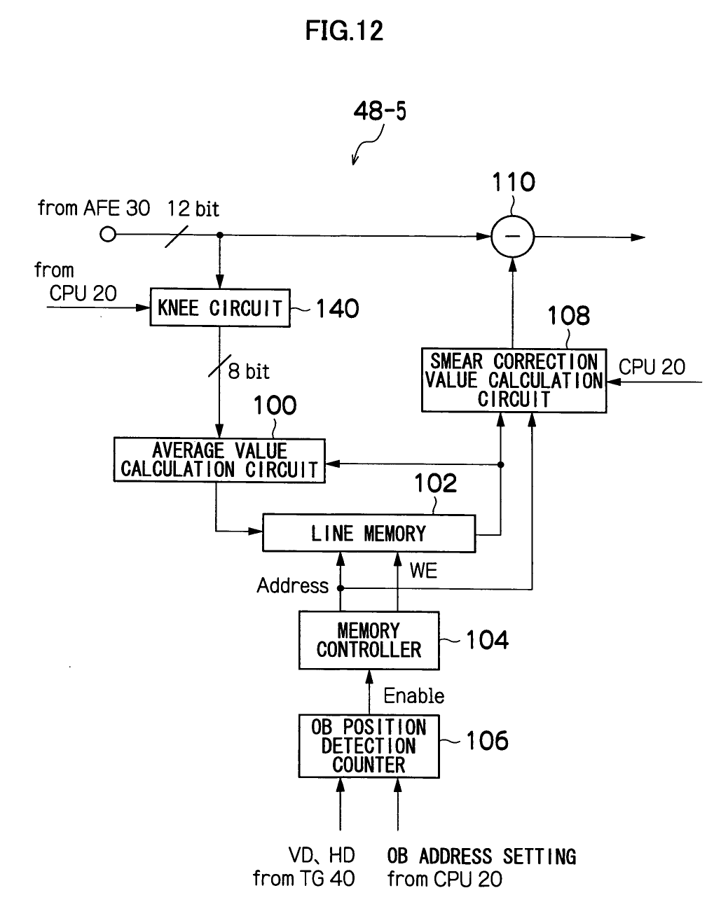

FIG. 12 is a block diagram showing a smear correction circuit according to a fifth embodiment of the present invention. The same components as in the first embodiment shown in FIG. 4 are designated by the same reference numerals, and detailed description thereof will be omitted.

A smear correction circuit 48-5 shown in FIG. 12 differs from the smear correction circuit 48-1 according to the first embodiment in that a knee circuit 140 is additionally provided in front of the average value calculation circuit 100.

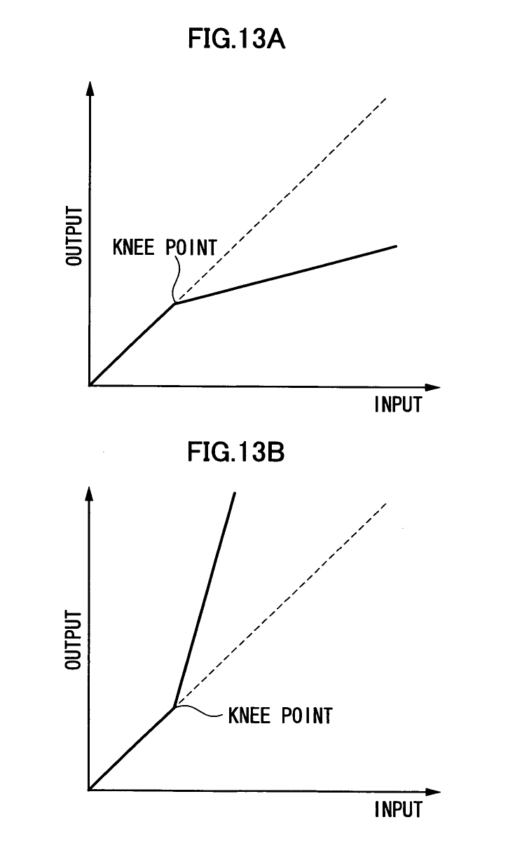

The knee circuit 140 is a circuit that compresses data equal to or higher than a predetermined knee point among the input 12-bit CCD-RAW data, as shown in FIG. 13A. For example, the knee circuit 140 may be constituted by a look-up table (LUT) having an input/output characteristic shown in FIG. 13A.

The knee circuit 140 compresses the 12-bit data into 8-bit data, thereby reducing the bit width, so that the size of the following stages of the smear correction circuit can be reduced.

### Sixth Embodiment

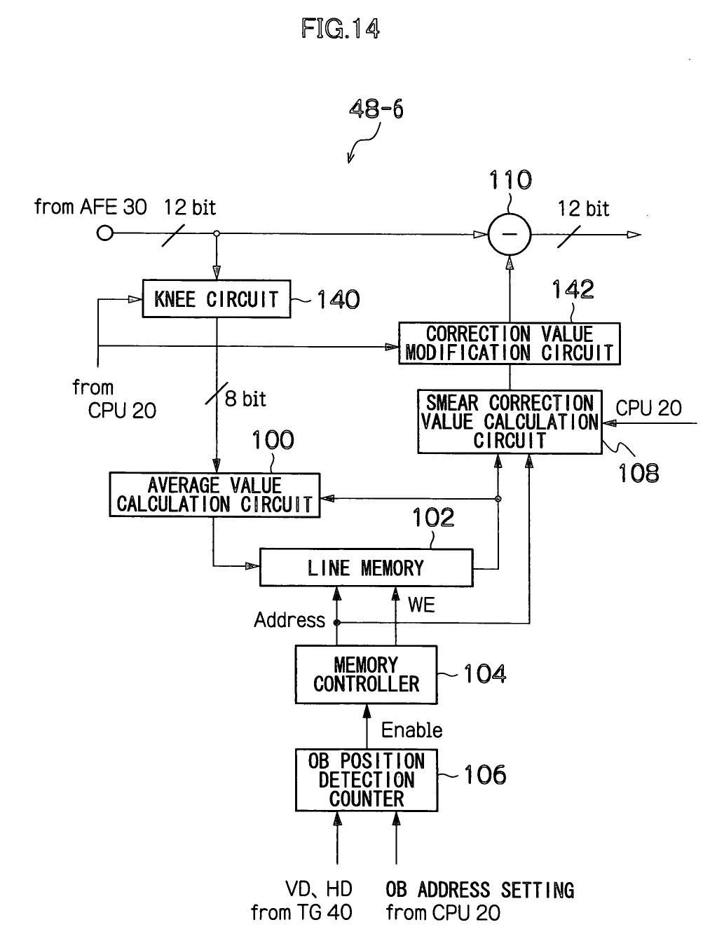

FIG. 14 is a block diagram showing a smear correction circuit according to a sixth embodiment of the present invention. The same components as in the fifth embodiment shown in FIG. 12 are designated by the same reference numerals, and detailed description thereof will be omitted.

A smear correction circuit 48-6 shown in FIG. 14 differs from the smear correction circuit 48-5 according to the fifth embodiment in that a correction value modification circuit 142 is additionally provided following the smear correction value calculation circuit 108.

As described above, the knee circuit 140 compresses data equal to or higher than a predetermined knee point. Therefore, a smear correction value equal to or higher than the predetermined knee point is also compressed.

The correction value modification circuit 142 is a circuit for recovering the compressed smear correction value equal to or higher than the knee point to the uncompressed value and has an inverse input/output characteristic to the input/output characteristic of the knee circuit 140 (shown in FIG. 13A) for modifying the smear correction value, as shown in FIG. 13B.

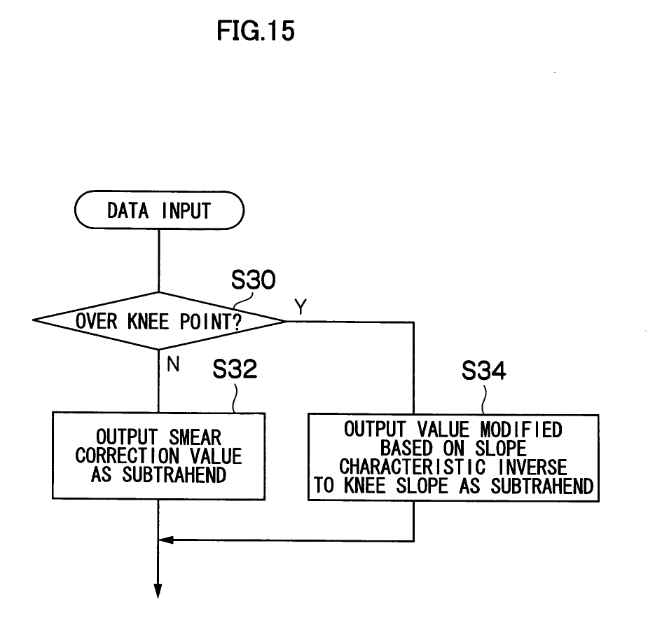

FIG. 15 is a flowchart for illustrating an operation of the correction value modification circuit 142.

Referring to FIG. 15, the correction value modification circuit 142 compares the smear correction value input from the smear correction value calculation circuit 108 with the knee point input from the CPU 20 to determine whether the smear correction value is higher than the knee point or not (step S30).

If the smear correction value is not higher than the knee point, the correction value modification circuit 142 outputs the smear correction value to the subtraction circuit 110 as a subtrahend (step S32). If the smear correction value is higher than the knee point, the smear correction value modification circuit 142 performs a correction calculation based on a slope characteristic inverse to the knee slope and outputs the resulting value as a subtrahend (step S34).

The correction value modification circuit 142 can be constituted by an LUT having an input/output characteristic shown in FIG. 13B.

### Seventh Embodiment

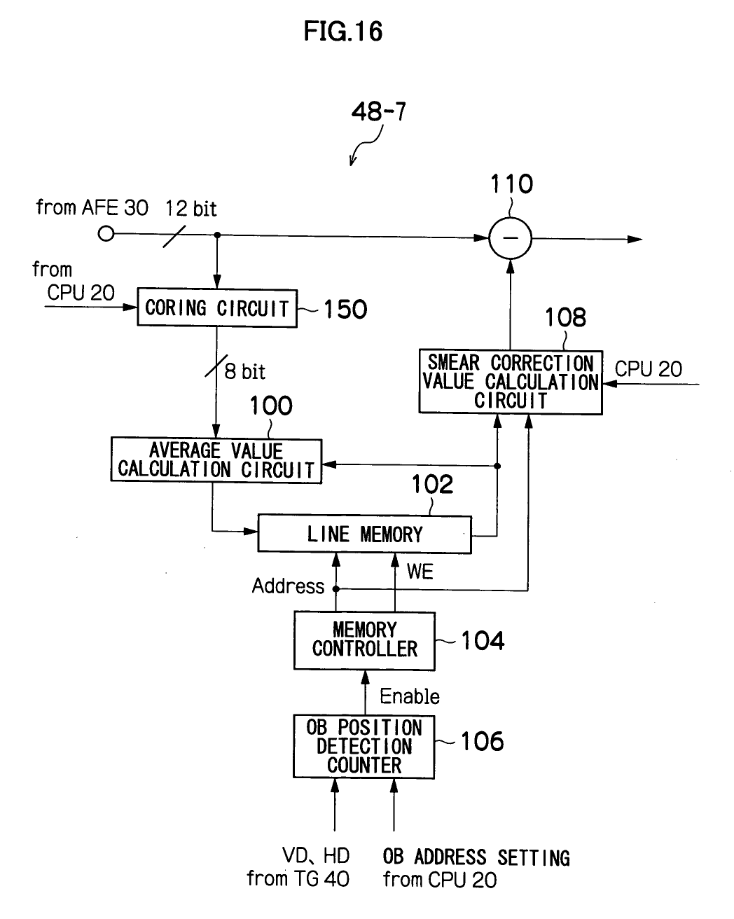

FIG. 16 is a block diagram showing a smear correction circuit according to a seventh embodiment of the present invention. The same components as in the first embodiment shown in FIG. 4 are designated by the same reference numerals, and detailed description thereof will be omitted.

A smear correction circuit 48-7 shown in FIG. 16 differs from the smear correction circuit 48-1 according to the first embodiment in that a coring circuit 150 is additionally provided in front of the average value calculation circuit 100.

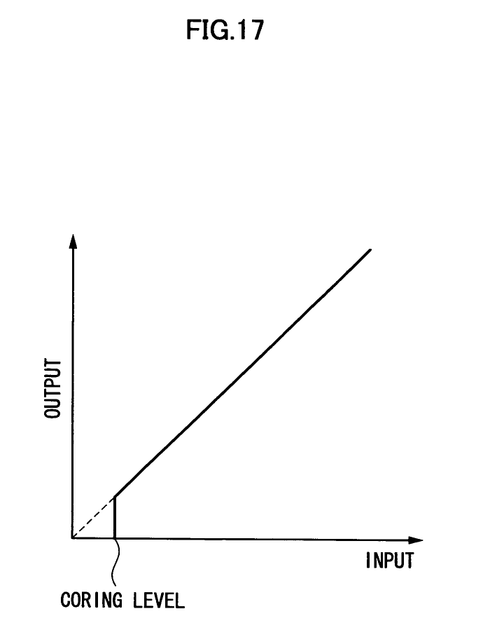

The coring circuit 150 has a predetermined coring level set by the CPU 20. As shown in FIG. 17, the coring circuit 150 outputs the input 12-bit data excluding any data that is equal to or lower than the predetermined coring level. The coring level is preferably determined to accommodate a noise component.

The coring circuit 150 allows the OB value free from the effect of noise to be determined.

### Eighth Embodiment

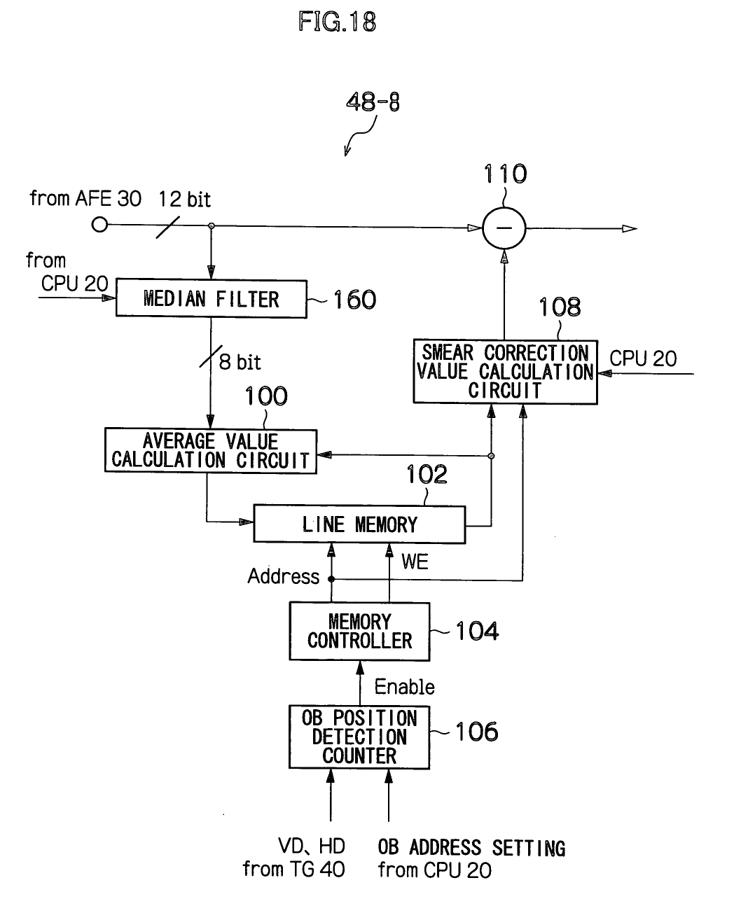

FIG. 18 is a block diagram showing a smear correction circuit according to an eighth embodiment of the present invention. The same components as in the first embodiment shown in FIG. 4 are designated by the same reference numerals, and detailed description thereof will be omitted.

A smear correction circuit 48-8 shown in FIG. 18 differs from the smear correction circuit 48-1 according to the first embodiment in that a median filter 160 is additionally provided in front of the average value calculation circuit 100.

For example, the median filter 160 performs a filtering processing involving calculating the median of data of a filter size of 3 by 3 pixels or 5 by 5 pixels centered on a attention pixel and replacing the data of the attention pixel with the calculated median. In the case where the data of the attention pixels is a singular point with respect to the data of surrounding pixels, the median filter 160 replaces the data of the attention pixel with data that is not a singular point (that is, the median filter 160 removes the singular point).

For example, the data at the point b where a pixel defect in the OB area results in a great OB value shown in FIG. 5 can be replaced with a value close to the average OB value. Thus, the OB value can be accurately determined.

### Ninth Embodiment

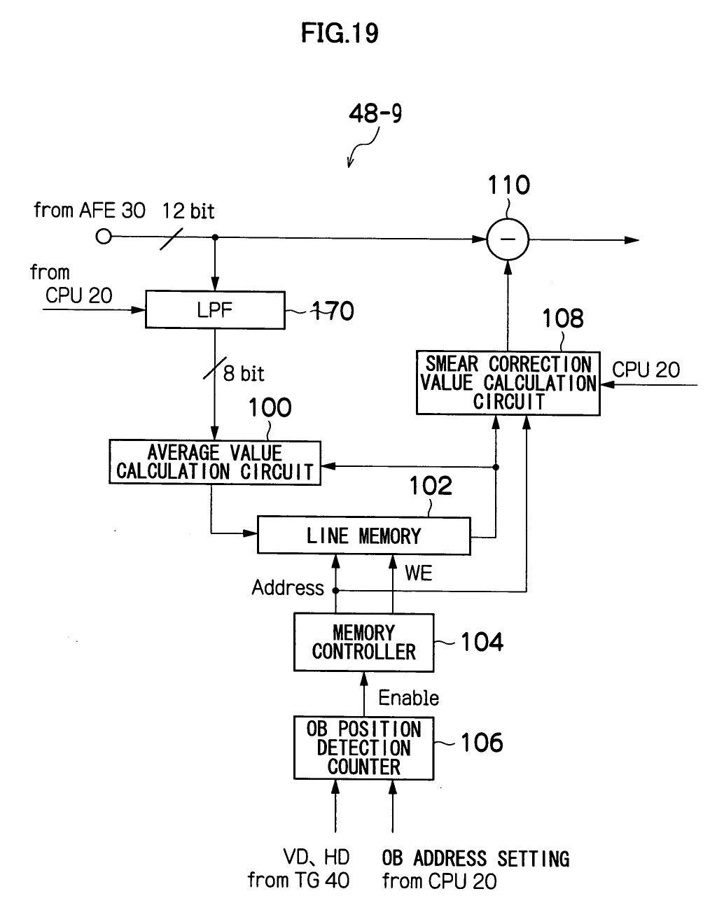

FIG. 19 is a block diagram showing a smear correction circuit according to a ninth embodiment of the present invention. The same components as in the first embodiment shown in FIG. 4 are designated by the same reference numerals, and detailed description thereof will be omitted.

A smear correction circuit 48-9 shown in FIG. 19 differs from the smear correction circuit 48-1 according to the first embodiment in that a low-pass filter (LPF) 170 is additionally provided in front of the average value calculation circuit 100.

The LPF 170 averages the data of pixels in the vicinity of a attention pixel including the attention pixel and outputs the average data as the data of the attention pixel. Thus, noise and data of a singular point can be eliminated, so that the OB value free from the effect of noise or the like can be determined.

While, in the embodiments described above, it has been supposed that the bit width of the CCD-RAW data is 12-bit, and the bit width of the data reduced in size for calculation of the OB value is 8-bit, the bit widths of the data are not limited thereto. Furthermore, while it has been supposed that the number of lines of pixels constituting the OB area is 2, the number of lines of pixels constituting the OB area is not limited thereto but may be 8, 16 or the like. The OB value can be calculated more accurately as the number of lines increases.

Furthermore, the filter for removing noise or the like is not limited to the median filter 160 and the LPF 170, but may be any appropriate digital filter, such as an isolated point removing filter.

What is claimed is:

1. An image pickup apparatus, comprising:
a solid-state image sensor having an effective pixel area and an optical black area composed of a plurality of lines of pixels;
an A/D converter which converts analog signals output from the solid-state image sensor into digital signals having a predetermined bit width;
an average value calculation device which receives digital signals having a bit width smaller than the bit width of the digital signals derived from the optical black area and calculates one line of digital signals by averaging digital signals derived from the plurality of lines of pixels based on the received digital signals;
a line memory which stores the one line of digital signals having the smaller bit width calculated by the average value calculation device;
a smear detection device which detects the horizontal position of a pixel in the effective pixel area at which a smear occurs, based on the one line of digital signals stored in the line memory; and
a smear correction device which corrects, based on the digital signals stored in the line memory, a digital signal derived from the pixel position detected by the smear detection device of the digital signals having the predetermined bit width derived from the effective pixel area.

2. The image pickup apparatus according to claim 1, wherein the smear detection device comprises:
a calculation device which calculates the difference between an average value of the digital signals derived from the optical black area of the solid-state image sensor and each of the digital signals stored in the line memory; and
a comparison device which detects the horizontal position of a pixel at which a smear occurs based on comparison between the calculated difference and a preset threshold.

3. The image pickup apparatus according to claim 1, wherein the smear correction device determines a difference between the digital signal derived from the pixel position detected by the smear detection device and the average value of the digital signals derived from the optical black area of the solid-state image sensor and subtracts the determined difference from the digital signals having the predetermined bit width derived from the effective pixel area.

4. The image pickup apparatus according to claim 2, wherein the smear correction device determines a difference between the digital signal derived from the pixel position detected by the smear detection device and the average value of the digital signals derived from the optical black area of the solid-state image sensor and subtracts the determined difference from the digital signals having the predetermined bit width derived from the effective pixel area.

5. The image pickup apparatus according to claim 3, further comprising a correction assessment device which cancels the smear correction based on the difference in the case where the determined difference is greater than a predetermined value.

6. The image pickup apparatus according to claim 4, further comprising a correction assessment device which cancels the smear correction based on the difference in the case where the determined difference is greater than a predetermined value.

7. The image pickup apparatus according to claim 1, further comprising a bit selector which is provided at a stage preceding the average value calculation device, receives the digital signals having the predetermined bit width, derives a digital signal composed of a width of bits at any bit positions from each of the digital signals having the predetermine bit width, and outputs the digital signal to the average value calculation device.

8. The image pickup apparatus according to claim 6, further comprising a bit selector which is provided at a stage preceding the average value calculation device, receives the digital signals having the predetermined bit width, derives a digital signal composed of a width of bits at any bit positions from each of the digital signals having the predetermine bit width, and outputs the digital signal to the average value calculation device.

9. The image pickup apparatus according to claim 1, further comprising a limiter which is provided at a stage preceding the average value calculation device and limits the digital signal input to the average value calculation device to a preset numerical value.

10. The image pickup apparatus according to claim 6, further comprising a limiter which is provided at a stage preceding the average value calculation device and limits the digital signal input to the average value calculation device to a preset numerical value.

11. The image pickup apparatus according to claim 1, further comprising a knee circuit which is provided at a stage preceding the average value calculation device and performs a knee correction of the digital signal input to the average value calculation device.

12. The image pickup apparatus according to claim 6, further comprising a knee circuit which is provided at a stage preceding the average value calculation device and performs a knee correction of the digital signal input to the average value calculation device.

13. The image pickup apparatus according to claim 11, further comprising a correction value modification device which imparts an input/output characteristic inverse to a knee characteristic of the knee circuit to the digital signal derived from the pixel position detected by the smear detection device and stored in the line memory, which is subtracted from the digital signal derived from the pixel position.

14. The image pickup apparatus according to claim 12, further comprising a correction value modification device which imparts an input/output characteristic inverse to a knee characteristic of the knee circuit to the digital signal derived from the pixel position detected by the smear detection device and stored in the line memory, which is subtracted from the digital signal derived from the pixel position.

15. The image pickup apparatus according to claim 1, further comprising a coring circuit which is provided at a stage preceding the average value calculation device and performs a coring correction of the digital signal input to the average value calculation device.

16. The image pickup apparatus according to claim 6, further comprising a coring circuit which is provided at a stage preceding the average value calculation device and performs a coring correction of the digital signal input to the average value calculation device.

17. The image pickup apparatus according to claim 1, further comprising a digital filter which is provided at a stage preceding the average value calculation device and performs filtering of the digital signal input to the average value calculation device, the digital filter reducing the value of a attention point in the case where the value of the attention point is greater than the value of a point in the vicinity of the attention point.

18. The image pickup apparatus according to claim 6, further comprising a digital filter which is provided at a stage preceding the average value calculation device and performs filtering of the digital signal input to the average value calculation device, the digital filter reducing the value of a attention point in the case where the value of the attention point is greater than the value of a point in the vicinity of the attention point.

19. The image pickup apparatus according to claim 17, wherein the digital filter is a median filter, a low-pass filter or an isolated point removing filter.

20. The image pickup apparatus according to claim 18, wherein the digital filter is a median filter, a low-pass filter or an isolated point removing filter.
